(19) United States
(12) Patent Application Publication
(10) Pub. No.: US 2021/0044903 A1
(43) Pub. Date: Feb. 11, 2021

(54) PIEZOELECTRIC SPEAKER

(71) Applicant: TOKIN CORPORATION, Sendai-shi (JP)

(72) Inventors: Yoshiyuki ABE, Tokyo (JP); Masafumi KATSUNO, Tokyo (JP)

(73) Assignee: TOKIN CORPORATION, Sendai-shi (JP)

(21) Appl. No.: 16/932,935

(22) Filed: Jul. 20, 2020

(30) Foreign Application Priority Data
Aug. 8, 2019 (JP) 2019-146171
Jun. 22, 2020 (JP) 2020-106868

(51) Int. Cl. H04R 17/00; H04R 7/04; H04R 1/02

(52) U.S. Cl. CPC H04R 17/00; H04R 1/02; H04R 7/04

(57) ABSTRACT

A piezoelectric speaker comprises a frame, a piezoelectric element, a diaphragm, an edge, a spacer, a cover and a supporting portion. The frame has an upper surface and a lower surface in an up-down direction. The diaphragm has an outer peripheral end in a horizontal plane perpendicular to the up-down direction. The cover has an outer peripheral end in the horizontal plane. In the horizontal plane, the outer peripheral end of the diaphragm is positioned inside the outer peripheral end of the cover. The edge supports the outer peripheral end of the diaphragm so that the outer peripheral end of the diaphragm is freely vibratable. The spacer is fixed to both of the piezoelectric element and the diaphragm in the up-down direction. The cover is positioned above the diaphragm in the up-down direction. The supporting portion is positioned on the frame and supports the cover.

### CROSS REFERENCE TO RELATED APPLICATIONS

This application is based on and claims priority under 35 U.S.C. § 119 to Japanese Patent Application No. JP2019-146171 filed Aug. 8, 2019 and Japanese Patent Application No. JP2020-106868 filed Jun. 22, 2020, the contents of which are incorporated herein in their entirety by reference.

### BACKGROUND OF THE INVENTION

This invention relates to a piezoelectric speaker comprising a piezoelectric element.

JPB5977473 (Patent Document 1) discloses a piezoelectric speaker of this type. More specifically, referring to FIG. 8, the piezoelectric speaker 900 of Patent Document 1 comprises a frame 910, piezoelectric elements 920, diaphragms 930, dampers 940, spacers 950 and fixing members 960. Opposite ends 922 of the piezoelectric element 920 in an X-direction are supported by the frame 910. The diaphragm 930 is attached on a positive Z-surface of the damper 940. The spacer 950 couples the piezoelectric element 920 and the damper 940 with each other in a Z-direction. The fixing member 960 attaches a negative Z-surface of an outer peripheral portion 942 of the damper 940 and a positive Z-surface of the frame 910 to each other.

In the piezoelectric speaker 900 of Patent Document 1, the diaphragm 930 is fixed to the frame 910 via the damper 940 and the fixing member 960. Thus, deviation of the diaphragm 930 in the Z-direction is limited and thereby a sound pressure level, which can be produced by the piezoelectric speaker 900, is limited.

There is a need for a piezoelectric speaker to produce a higher sound pressure level.

### SUMMARY OF THE INVENTION

It is therefore an object of the present invention to provide a piezoelectric speaker which can produce a higher sound pressure level.

One aspect of the present invention provides a piezoelectric speaker comprising a frame, a piezoelectric element, a diaphragm, an edge, a spacer, a cover and a supporting portion. The frame surrounds a predetermined region. The frame has an upper surface and a lower surface in an up-down direction. The piezoelectric element is fixed to the lower surface of the frame. The piezoelectric element is positioned below the predetermined region in the up-down direction. The diaphragm is positioned above the predetermined region in the up-down direction. The diaphragm has an outer peripheral end in a horizontal plane perpendicular to the up-down direction. The cover has an outer peripheral end in the horizontal plane. In the horizontal plane, the outer peripheral end of the diaphragm is positioned inside the outer peripheral end of the cover. The edge is fixed to the upper surface of the frame. The edge supports the outer peripheral end of the diaphragm so that the outer peripheral end of the diaphragm is freely vibratable. The spacer is arranged in the predetermined region. The spacer is fixed to both of the piezoelectric element and the diaphragm in the up-down direction. The cover is positioned above the diaphragm in the up-down direction. The supporting portion is positioned on the frame and supports the cover.

The piezoelectric speaker of the present invention is configured as follows: the outer peripheral end of the diaphragm is positioned inside the outer peripheral end of the cover in the horizontal plane perpendicular to the up-down direction; and the cover is positioned above the diaphragm in the up-down direction. Thus, in a frequency range of 2 kHz to 20 kHz which is included in the audible range, the piezoelectric speaker of the present invention does not have a frequency band whose intensity is extremely reduced. In other words, the piezoelectric speaker of the present invention can produce a flatter frequency response in sound pressure level across the frequency range of 2 kHz to 20 kHz.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a cross-sectional view showing a piezoelectric speaker according to a first embodiment of the present invention.

FIG. 2 is a cross-sectional view showing the piezoelectric speaker of FIG. 1, except for omission of a cover and a supporting portion.

FIG. 3 is an enlarged view showing a part of the piezoelectric speaker which is enclosed by broken line A of FIG. 2.

FIG. 4 is a top view showing the piezoelectric speaker of FIG. 1.

FIG. 5 is a top view showing the piezoelectric speaker of FIG. 2.

FIG. 6 is a cross-sectional view showing a piezoelectric speaker according to a second embodiment of the present invention, except for omission of a cover and a supporting portion.

FIG. 7 is a top view showing the piezoelectric speaker of FIG. 6.

FIG. 8 is a cross-sectional view showing a piezoelectric speaker of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

### First Embodiment

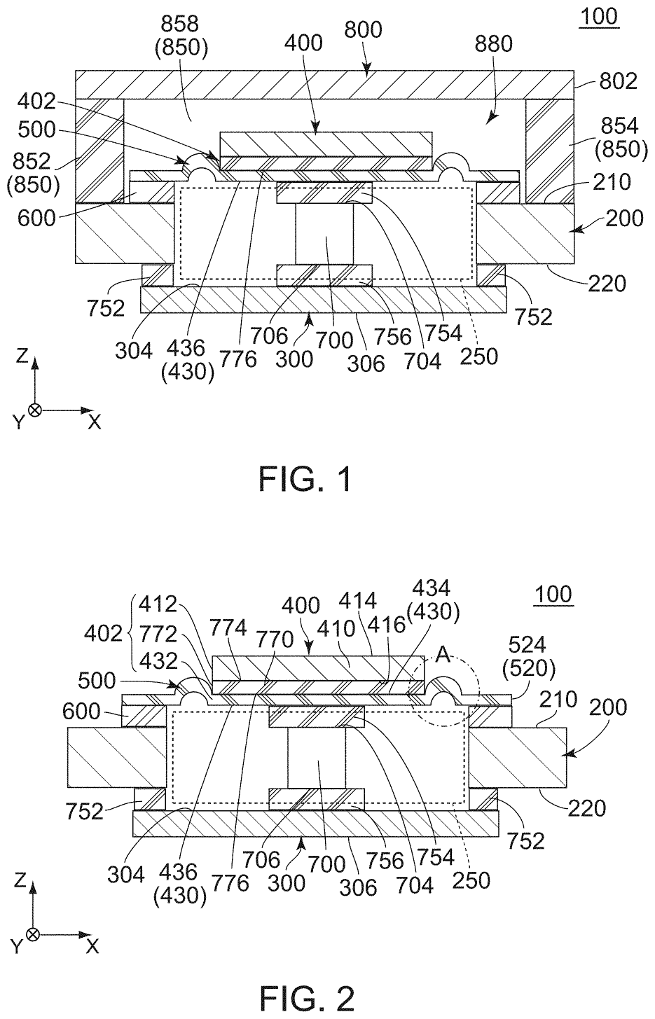

As shown in FIG. 1, a piezoelectric speaker 100 according to a first embodiment of the present invention comprises a frame 200, a piezoelectric element 300, a diaphragm 400, an edge 500, an adhesive layer 600, a spacer 700, a cover 800 and a supporting portion 850. The piezoelectric speaker 100 of the present embodiment has a predetermined region 250 therein.

Referring to FIG. 2, the frame 200 of the present embodiment is made of metal. More specifically, the frame 200 is made of stainless steel. The frame 200 of the present embodiment surrounds the predetermined region 250. More specifically, the frame 200 surrounds the predetermined region 250 in a plane perpendicular to an up-down direction. The frame 200 has an upper surface 210 and a lower surface 220 in the up-down direction. In the present embodiment, the up-down direction is a Z-direction while the plane perpendicular to the up-down direction is an XY-plane. Specifically, it is assumed that upward is a positive Z-direction while downward is a negative Z-direction.

Referring to FIG. 2, the piezoelectric element 300 of the present embodiment is a multilayer piezoelectric element which is formed by stacking piezoelectric layers each made of piezoelectric ceramics, wherein the piezoelectric layer expands and contracts when voltage is applied to the piezoelectric layer in the up-down direction. However, the present invention is not limited thereto. The piezoelectric element 300 may be a bimorph piezoelectric element, or may be a unimorph piezoelectric element. Lead wires and terminals, through which voltage is applied to the piezoelectric element 300, are omitted in FIG. 1.

As shown to FIG. 2, the piezoelectric element 300 of the present embodiment has a flat-plate shape perpendicular to the up-down direction. The piezoelectric element 300 has an upper surface 304 and a lower surface 306 in the up-down direction. The piezoelectric element 300 is fixed to the lower surface 220 of the frame 200. The piezoelectric element 300 is positioned below the predetermined region 250 in the up-down direction. Specifically, the upper surface 304 of the piezoelectric element 300 is positioned below the predetermined region 250 in the up-down direction.

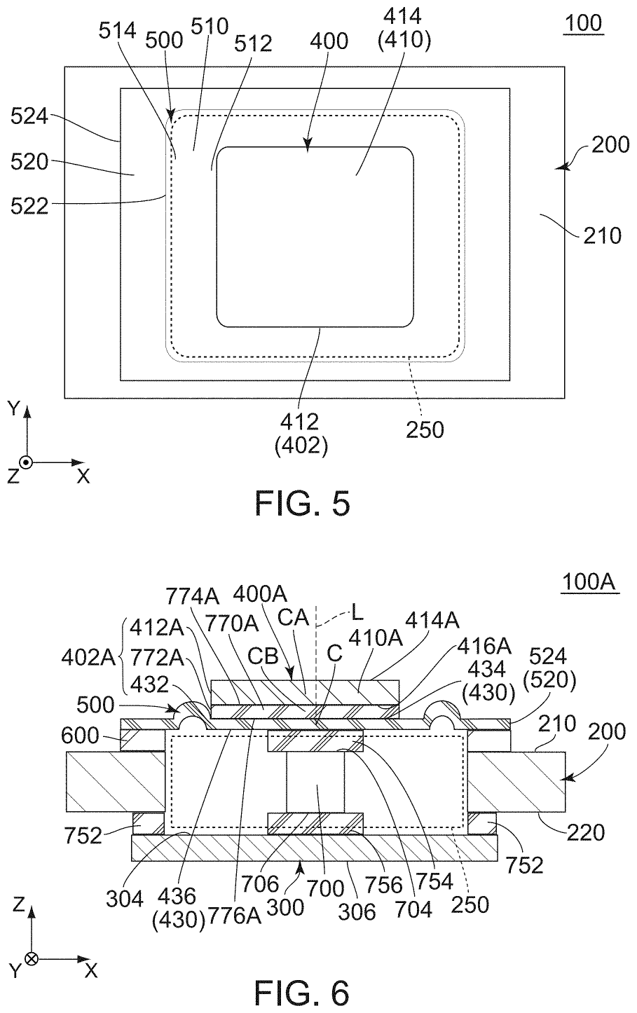

Referring to FIG. 2, the diaphragm 400 of the present embodiment is made of resin. More specifically, the diaphragm 400 is made of polyethylene terephthalate (PET). The diaphragm 400 has a flat-plate shape perpendicular to the up-down direction. As shown in FIG. 5, the diaphragm 400 has an outer peripheral end 402 in a perpendicular direction perpendicular to the up-down direction. The outer peripheral end 402 of the diaphragm 400 has a substantially rectangular shape. The substantially rectangular shape of the outer peripheral end 402 has two sides, each of which is parallel to a first horizontal direction perpendicular to the up-down direction, and two sides each parallel to a second horizontal direction perpendicular to both the up-down direction and the first horizontal direction. In the present embodiment, the first horizontal direction is an X-direction while the second horizontal direction is a Y-direction. The first horizontal direction is also referred to as a right-left direction. Specifically, it is assumed that rightward is a negative X-direction while leftward is a positive X-direction. The second horizontal direction is also referred to as a front-rear direction. Specifically, it is assumed that forward is a negative Y-direction while rearward is a positive Y-direction.

As shown in FIG. 2, the diaphragm 400 of the present embodiment has an upper surface 414 and a lower surface 436 in the up-down direction. The diaphragm 400 is positioned above the predetermined region 250 in the up-down direction. Specifically, the lower surface 436 of the diaphragm 400 is positioned above the predetermined region 250 in the up-down direction. As shown in FIG. 5, the outer peripheral end 402 of the diaphragm 400 is positioned inside the predetermined region 250 in a horizontal plane perpendicular to the up-down direction. Specifically, the outer peripheral end 402 of the diaphragm 400 is positioned inward of the predetermined region 250 in the perpendicular direction perpendicular to the up-down direction.

The diaphragm 400 meets an inequality of 100 MPa≤G1≤4 MPa, where G1 is a Young's modulus of the diaphragm 400. When the diaphragm 400 having a Young's modulus G1 of less than 100 MPa is pushed by the piezoelectric element 300 via the spacer 700, the diaphragm 400 is not moved uniformly and only a part of the diaphragm 400, which is directly pushed by the spacer 700, is moved. Accordingly, the diaphragm 400 having a Young's modulus G1 of less than 100 MPa cannot produce a high sound pressure level. Thus, it is unfavorable for the diaphragm 400 to have a Young's modulus G1 of less than 100 MPa. Specifically, when the diaphragm 400 having a Young's modulus G1 of less than 100 MPa is pushed by the piezoelectric element 300 via the spacer 700, the part of the diaphragm 400, which is directly pushed by the spacer 700, is synchronously moved with the spacer 700 while a remaining part of the diaphragm 400, which is not directly pushed by the spacer 700, is not synchronously moved with the spacer 700. Accordingly, the diaphragm 400 having a Young's modulus G1 of less than 100 MPa cannot produce a high sound pressure level. Thus, it is unfavorable for the diaphragm 400 to have a Young's modulus G1 of less than 100 MPa. If the diaphragm 400 has a Young's modulus G1 of more than 4 MPa, the diaphragm 400, which is pushed by the piezoelectric element 300, is mainly moved to be bent. Thus, it is unfavorable for the diaphragm 400 to have a Young's modulus G1 of more than 4 GPa.

The diaphragm 400 meets an inequality of 0.04 g≤W≤0.1 g, where W is a weight of the diaphragm 400. If W is more than 0.1 g, the piezoelectric element 300, which is required for driving the diaphragm 400, must have an increased size and an increased number of the stacked piezoelectric layers so that the piezoelectric element 300 has an increased cost. Thus, it is unfavorable for the diaphragm 400 to have a weight W of more than 0.1 g.

As shown in FIG. 2, the diaphragm 400 of the present embodiment comprises a main vibration portion 410 and a supporting body 430.

As shown in FIG. 2, the main vibration portion 410 has a flat-plate shape perpendicular to the up-down direction. The main vibration portion 410 has an outer peripheral end 412 in the perpendicular direction. The outer peripheral end 412 is exposed to the outside of the diaphragm 400 in the perpendicular direction. The main vibration portion 410 has an upper surface 414 and a lower surface 416 in the up-down direction. The upper surface 414 is exposed to the outside of the diaphragm 400.

As shown in FIG. 2, the supporting body 430 of the present embodiment has a flat-plate shape perpendicular to the up-down direction. The supporting body 430 has an outer peripheral end 432 in the perpendicular direction. The supporting body 430 has an upper surface 434 and a lower surface 436 in the up-down direction. The supporting body 430 is positioned above the predetermined region 250 in the up-down direction. In other words, the lower surface 436 of the supporting body 430 is positioned above the predetermined region 250 in the up-down direction.

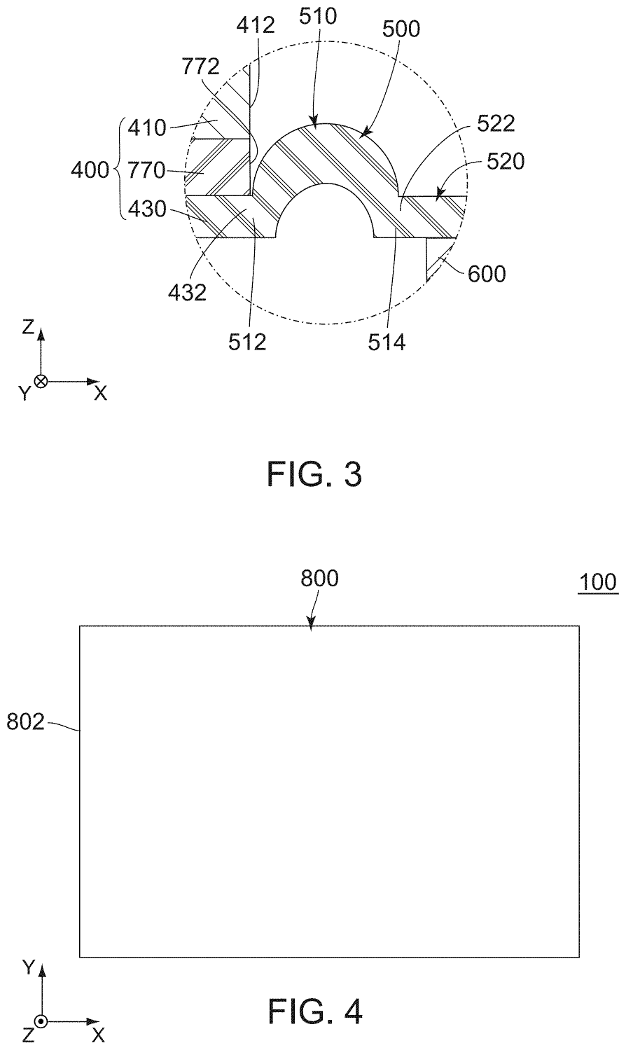

Referring to FIG. 3, the edge 500 of the present embodiment is made of resin. More specifically, the edge 500 is made of polyethylene naphthalate. As shown in FIG. 3, the edge 500 has an arc-like cross-section. The edge 500 has an inner end 512 and an outer end 514. The piezoelectric speaker 100 meets an inequality of 1.5≤G1/G2≤5, where G2 is a Young's modulus of the edge 500. If the piezoelectric speaker 100 meets an inequality of G1/G2<1.5, the diaphragm 400, which is pushed by the piezoelectric element 300, is mainly moved to be bent. Thus, it is unfavorable for the piezoelectric speaker 100 to meet the inequality of G1/G2<1.5. If the piezoelectric speaker 100 meets an inequality of G1/G2>5, the edge 500 is too softer than the diaphragm 400. Specifically, in the piezoelectric speaker 100 meeting the inequality of G1/G2>5, the diaphragm 400, which is pushed by the piezoelectric element 300 via spacer 700, is not moved uniformly in the up-down direction while movement of the diaphragm 400 includes its rotational movement about an axis parallel to the up-down direction. Thus, it is unfavorable for the piezoelectric speaker 100 to meet the inequality of G1/G2>5.

As shown in FIG. 3, the edge 500 of the present embodiment has a curved portion 510 and a flat-plate portion 520.

As shown in FIG. 5, the curved portion 510 of the present embodiment has an outer periphery with a substantially rectangular shape when the edge 500 is viewed along the up-down direction. As shown in FIG. 3, the curved portion 510 has an arc-like cross-section in a plane which is formed by the up-down direction and the perpendicular direction. The curved portion 510 has an inner end 512 and an outer end 514. The inner end 512 defines an inner end of the curved portion 510 in the perpendicular direction. The outer end 514 defines an outer end of the curved portion 510 in the perpendicular direction.

As shown in FIG. 2, the flat-plate portion 520 of the present embodiment has a flat-plate shape perpendicular to the up-down direction. As shown in FIG. 5, the flat-plate portion 520 has an outer periphery with a rectangular shape when the edge 500 is viewed along the up-down direction. The flat-plate portion 520 has an inner end 522 and an outer end 524. The inner end 522 defines an inner end of the flat-plate portion 520 in the perpendicular direction. The outer end 524 defines an outer end of the flat-plate portion 520 in the perpendicular direction. The flat-plate portion 520 is positioned outward beyond the curved portion 510 in the perpendicular direction. The flat-plate portion 520 is coupled with the curved portion 510 in the perpendicular direction. In detail, the inner end 522 of the flat-plate portion 520 is coupled with the outer end 514 of the curved portion 510 in the perpendicular direction.

As shown in FIGS. 2 and 3, the edge 500 of the present embodiment is fixed to the upper surface 210 of the frame 200. The edge 500 of the present embodiment supports the outer peripheral end 402 of the diaphragm 400 so that the outer peripheral end 402 of the diaphragm 400 is freely vibratable.

As shown in FIG. 2, the edge 500 is fixed to the upper surface 210 of the frame 200 via the adhesive layer 600. More specifically, the flat-plate portion 520 of the edge 500 is fixed to the upper surface 210 of the frame 200 via the adhesive layer 600. The curved portion 510 of the edge 500 is not fixed to the upper surface 210 of the frame 200.

As shown in FIG. 3, the inner end 512 of the curved portion 510 of the edge 500 supports the outer peripheral end 432 of the supporting body 430 of the diaphragm 400 so that the outer peripheral end 432 of the supporting body 430 of the diaphragm 400 is freely vibratable. The inner end 512 of the curved portion 510 of the edge 500 is coupled with the outer peripheral end 432 of the supporting body 430 of the diaphragm 400 in the perpendicular direction. In other words, the supporting body 430 is formed integrally with the edge 500.

As understood from FIGS. 2 and 3, the curved portion 510 is positioned above the predetermined region 250 in the up-down direction. The flat-plate portion 520 is positioned above the predetermined region 250 in the up-down direction,

As shown in FIG. 2, the adhesive layer 600 of the present embodiment is positioned between the frame 200 and the edge 500 in the up-down direction. More specifically, the adhesive layer 600 attaches the upper surface 210 of the frame 200 and the flat-plate portion 520 of the edge 500 to each other in the up-down direction. The curved portion 510 of the edge 500 is not attached on the adhesive layer 600.

Referring to FIG. 2, the spacer 700 of the present embodiment is made of resin. More specifically, the spacer 700 is made of polycarbonate. In the piezoelectric speaker 100 of the present embodiment, the number of the spacer 700 is one. The spacer 700 has a square cross-section in the plane perpendicular to the up-down direction.

Referring to FIGS. 2 and 5, the spacer 700 is positioned at the center of the piezoelectric speaker 100 in the perpendicular direction. The spacer 700 is positioned at the center of the piezoelectric speaker 100 in the first horizontal direction. The spacer 700 is positioned at the center of the piezoelectric speaker 100 in the second horizontal direction.

Referring to FIGS. 2 and 5, the spacer 700 is positioned at the center of the diaphragm 400 in the perpendicular direction. The spacer 700 is positioned at the center of the diaphragm 400 in the first horizontal direction. The spacer 700 is positioned at the center of the diaphragm 400 in the second horizontal direction.

Referring to FIG. 2, the spacer 700 is positioned at the center of the piezoelectric element 300 in the perpendicular direction. The spacer 700 is positioned at the center of the piezoelectric element 300 in the first horizontal direction. The spacer 700 is positioned at the center of the piezoelectric element 300 in the second horizontal direction.

As shown in FIG. 2, the spacer 700 of the present embodiment is arranged in the predetermined region 250. The spacer 700 is fixed to both of the piezoelectric element 300 and the diaphragm 400 in the up-down direction. The spacer 700 has an upper surface 704 and a lower surface 706 in the up-down direction.

Referring to FIGS. 1 and 4, the cover 800 of the present embodiment is made of metal. However, the present invention is not limited thereto. Specifically, the cover 800 may be made of transparent resin or the like. The cover 800 has a flat-plate shape. However, the present invention is not limited thereto. Specifically, the cover 800 may have a curved shape, or may have a dome shape. The cover 800 has no slit, hole, or opening which pierces the cover 800 in the up-down direction. However, the present invention is not limited thereto. Specifically, the cover 800 may have a slit, hole or opening which pierces the cover 800 in the up-down direction.

As shown in FIGS. 4 and 5, the diaphragm 400 is completely covered with the cover 800 when the piezoelectric speaker 100 is viewed from above along the up-down direction. However, the present invention is not limited thereto. Specifically, the diaphragm 400 may be partly visible when the piezoelectric speaker 100 is viewed from above along the up-down direction.

As shown in FIGS. 1 and 4, the cover 800 has an outer peripheral end 802 in the perpendicular direction perpendicular to the up-down direction. The outer peripheral end 802 of the cover 800 has a substantially rectangular shape. The substantially rectangular shape of the cover 800 has two sides, each of which is parallel to the first horizontal direction perpendicular to the up-down direction, and two sides each parallel to the second horizontal direction perpendicular to both the up-down direction and the first horizontal direction. As understood from FIGS. 4 and 5, the outer peripheral end 802 of the cover 800 is positioned outside the outer peripheral end 402 of the diaphragm 400 in the horizontal plane perpendicular to the up-down direction. Specifically, the outer peripheral end 802 of the cover 800 is positioned outward of the outer peripheral end 402 of the diaphragm 400 in the perpendicular direction perpendicular to the up-down direction. In other words, the outer peripheral end 402 of the diaphragm 400 is positioned inside the outer peripheral end 802 of the cover 800 in the horizontal plane perpendicular to the up-down direction. Specifically, the outer peripheral end 402 of the diaphragm 400 is positioned inward of the outer peripheral end 802 of the cover 800 in the perpendicular direction perpendicular to the up-down direction.

As shown in FIG. 1, the cover 800 is positioned above the diaphragm 400 in the up-down direction. The cover 800 is spaced away from the diaphragm 400 in the up-down direction. In other words, the cover 800 is not brought into contact with the diaphragm 400 in the up-down direction. The cover 800 is positioned above the edge 500 in the up-down direction. The cover 800 is spaced away from the edge 500 in the up-down direction. In other words, the cover 800 is not brought into contact with the edge 500 in the up-down direction.

As shown in FIG. 1, the piezoelectric speaker 100 is formed with an air layer 880 between the cover 800 and the diaphragm 400. The air layer 880 is positioned between the cover 800 and the diaphragm 400 in the up-down direction.

Referring to FIG. 1, the supporting portion 850 of the present embodiment is an elastic body. However, the present invention is not limited thereto. The supporting portion 850 may be a rigid body. The supporting portion 850 extends in the up-down direction.

Referring to FIG. 1, the supporting portion 850 has an angular C-shape cross-section in the horizontal plane. The supporting portion 850 is positioned on the frame 200 and supports the cover 800. More specifically, the supporting portion 850 is positioned on the frame 200 and supports the outer peripheral end 802 of the cover 800. In the horizontal plane, the supporting portion 850 is opened only at its front end in the front-rear direction perpendicular to the up-down direction. In other words, the supporting portion 850 is closed at opposite ends in the right-left direction and is closed at its rear end in the front-rear direction. The air layer 880 communicates with the outside of the piezoelectric speaker 100 only at its front end. This configuration of the supporting portion 850 enables the piezoelectric speaker 100 of the present embodiment to produce forwardly directed sound wave.

As described above, the piezoelectric speaker 100 of the present embodiment is formed with the air layer 880 between the cover 800 and the diaphragm 400 since the piezoelectric speaker 100 has the cover 800. The air layer 880 increases air resistance to the diaphragm 400. Thus, in a frequency range of 2 kHz to 20 kHz which is included in the audible range, the piezoelectric speaker 100 of the present embodiment does not have a frequency band whose intensity is extremely reduced. In other words, the piezoelectric speaker 100 of the present embodiment can produce a flatter frequency response in sound pressure level across the frequency range of 2 kHz to 20 kHz. In order to effectively increase air resistance to the diaphragm 400, it is preferable for the cover 800 to be made of rigid material whose Young's modulus is 1 GPa or more. Specifically, in order to achieve that purpose, it is preferable for the cover 800 to be made of metal, resin, glass epoxy substrate or the like.

However, the present invention is not limited thereto, but the supporting portion 850 may be opened at at least one of its right, left and rear end. Specifically, the supporting portion 850 may be opened only at its opposite ends in the front-rear direction. The supporting portion 850 may be opened only at its front and right end. The supporting portion 850 may be opened only at its front and left end. The supporting portion 850 may be opened only at its opposite ends in the front-rear direction and its right end. The supporting portion 850 may be opened only at its opposite ends in the front-rear direction and its left end. The supporting portion 850 may be opened only at its opposite ends in the right-left direction and its front end. The supporting portion 850 may be opened at its opposite ends in the front-rear direction and its opposite ends in the right-left direction. The supporting portion 850 may be modified, provided that the supporting portion 850 is, at least in part, opened in the horizontal plane.

As shown in FIG. 1, the supporting portion 850 has a right supporting portion 852, a left supporting portion 854 and a rear supporting portion 858.

As shown in FIG. 1, the right supporting portion 852 of the present embodiment extends upward in the up-down direction from the upper surface 210 of the frame 200. The right supporting portion 852 is positioned right of the left supporting portion 854 in the right-left direction. The right supporting portion 852 is positioned right of the diaphragm 400 in the right-left direction. The right supporting portion 852 is positioned right of the edge 500 in the right-left direction. The right supporting portion 852 is positioned forward of the rear supporting portion 858 in the front-rear direction. The right supporting portion 852 couples the frame 200 and the cover 800 with each other. The right supporting portion 852 supports a right end of the cover 800. The right supporting portion 852 has a flat-plate shape perpendicular to the right-left direction. The right supporting portion 852 has no slit, hole, or opening which pierces the right supporting portion 852 in the right-left direction. The air layer 880 does not communicates with the outside of the piezoelectric speaker 100 at its right end. However, the present invention is not limited thereto. Specifically, the right supporting portion 852 may have a slit, hole, or opening, which pierces the right supporting portion 852 in the right-left direction, so that air layer 880 communicates with the outside of the piezoelectric speaker 100 at its right end.

As shown in FIG. 1, the left supporting portion 854 of the present embodiment extends upward in the up-down direction from the upper surface 210 of the frame 200. The left supporting portion 854 is positioned left of the right supporting portion 852 in the right-left direction. The left supporting portion 854 is positioned left of the diaphragm 400 in the right-left direction. The left supporting portion 854 is positioned left of the edge 500 in the right-left direction. The left supporting portion 854 is positioned forward of the rear supporting portion 858 in the front-rear direction. The left supporting portion 854 couples the frame 200 and the cover 800 with each other. The left supporting portion 854 supports a left end of the cover 800. The left supporting portion 854 has a flat-plate shape perpendicular to the right-left direction. The left supporting portion 854 has no slit, hole, or opening which pierces the left supporting portion 854 in the right-left direction. The air layer 880 does not communicates with the outside of the piezoelectric speaker 100 at its left end. However, the present invention is not limited thereto. Specifically, the left supporting portion 854 may have a slit, hole, or opening, which pierces the left supporting portion 854 in the right-left direction, so that air layer 880 communicates with the outside of the piezoelectric speaker 100 at its left end.

As shown in FIG. 1, the rear supporting portion 858 of the present embodiment extends upward in the up-down direction from the upper surface 210 of the frame 200. The rear supporting portion 858 is positioned rearward of the diaphragm 400 in the front-rear direction. The rear supporting portion 858 is positioned rearward of the edge 500 in the front-rear direction. The rear supporting portion 858 couples the frame 200 and the cover 800 with each other. The rear supporting portion 858 supports a rear end of the cover 800. The rear supporting portion 858 has a flat-plate shape perpendicular to the front-rear direction. The rear supporting portion 858 has no slit, hole, or opening which pierces the rear supporting portion 858 in the front-rear direction. The air layer 880 does not communicates with the outside of the piezoelectric speaker 100 at its rear end. However, the present invention is not limited thereto. Specifically, the rear supporting portion 858 may have a slit, hole, or opening, which pierces the rear supporting portion 858 in the front-rear direction, so that air layer 880 communicates with the outside of the piezoelectric speaker 100 at its rear end.

As shown in FIG. 2, the piezoelectric speaker 100 of the present embodiment further comprises first dampers 752, 754 and 756. Each of the first dampers 752, 754 and 756 is made of resin. More specifically, each of the first dampers 752, 754 and 756 is a double-sided tape which is formed from a base member made of polyethylene terephthalate (PET) whose upper and lower sides are coated with acrylic adhesive.

As shown in FIG. 2, the first damper 752 is provided at a first boundary between the frame 200 and the piezoelectric element 300. Specifically, the first damper 752 is provided at the first boundary between the lower surface 220 of the frame 200 and the upper surface 304 of the piezoelectric element 300 in the up-down direction. The first damper 752 is attached on both of the lower surface 220 of the frame 200 and the upper surface 304 of the piezoelectric element 300. The piezoelectric element 300 is coupled with the lower surface 220 of the frame 200 via the first damper 752

As shown in FIG. 2, the first damper 754 is provided at a second boundary between the diaphragm 400 and the spacer 700. Specifically, the first damper 754 is provided at the second boundary between the lower surface 436 of the diaphragm 400 and the upper surface 704 of the spacer 700 in the up-down direction. More specifically, the first damper 754 is provided at second boundary between the lower surface 436 of the supporting body 430 of the diaphragm 400 and the upper surface 704 of the spacer 700 in the up-down direction. The first damper 754 is attached on both of the lower surface 436 of the supporting body 430 of the diaphragm 400 and the upper surface 704 of the spacer 700. The spacer 700 is coupled with the lower surface 436 of the diaphragm 400 via the first damper 754.

As shown in FIG. 2, the first damper 756 is provided at a third boundary between the spacer 700 and the piezoelectric element 300. Specifically, the first damper 756 is provided at the third boundary between the lower surface 706 of the spacer 700 and the upper surface 304 of the piezoelectric element 300 in the up-down direction. The first damper 756 is attached on both of the lower surface 706 of the spacer 700 and the upper surface 304 of the piezoelectric element 300. The spacer 700 is coupled with the upper surface 304 of the piezoelectric element 300 via the first damper 756.

Since the piezoelectric speaker 100 of the present embodiment comprises the first dampers 752, 754 and 756, the piezoelectric speaker 100 has an increases loss around its resonant frequency while having an reduced loss at a non-resonant frequency so that the piezoelectric speaker 100 can produce an increased sound pressure level at the non-resonant frequency. In other words, the piezoelectric speaker 100 of the present embodiment can provide a flatter frequency response in sound pressure level since the piezoelectric speaker 100 comprises the first dampers 752, 754 and 756. However, the present invention is not limited thereto. Specifically, the first damper 752, 754, 756 may be arranged at at least one of the first boundary, the second boundary and the third boundary. Furthermore, the piezoelectric speaker 100 may comprises no first damper 752, 754, 756.

As shown in FIG. 2, the piezoelectric speaker 100 of the present embodiment further comprises a second damper 770. The second damper 770 is made of resin. More specifically, the second damper 770 is a double-sided tape which is formed from a base member made of polyethylene terephthalate (PET) whose upper and lower sides are coated with acrylic adhesive.

As shown in FIG. 2, the second damper 770 is arranged between the main vibration portion 410 and the supporting body 430 in the up-down direction. The second damper 770 has an outer peripheral end 772 in the perpendicular direction. Specifically, the outer peripheral end 402 of the diaphragm 400 consists of the outer peripheral end 412 of the main vibration portion 410, the outer peripheral end 772 of the second damper 770 and the outer peripheral end 432 of the supporting body 430. The second damper 770 has an upper surface 774 and a lower surface 776 in the up-down direction.

As shown in FIG. 2, the second damper 770 of the present embodiment is attached on the main vibration portion 410 in the up-down direction. More specifically, the upper surface 774 of the second damper 770 is attached on the lower surface 416 of the main vibration portion 410 in the up-down direction.

As shown in FIG. 2, the second damper 770 of the present embodiment is attached on the supporting body 430 in the up-down direction. More specifically, the lower surface 776 of the second damper 770 is attached on the upper surface 434 of the supporting body 430 in the up-down direction.

As shown in FIG. 2, the diaphragm 400 of the present embodiment consists of the main vibration portion 410, the second damper 770 and the supporting body 430. More specifically, the diaphragm 400 of the present embodiment is formed by stacking the main vibration portion 410, the second damper 770 and the supporting body 430 in that order from the top of the diaphragm 400 in the up-down direction.

Since the piezoelectric speaker 100 of the present embodiment further comprises the second damper 770, the piezoelectric speaker 100 has a further increased loss around its resonant frequency while having a further reduced loss at a non-resonant frequency so that the piezoelectric speaker 100 can produce a further increased sound pressure level at the non-resonant frequency. In other words, the piezoelectric speaker 100 of the present embodiment can provide a more flatter frequency response in sound pressure level since the piezoelectric speaker 100 further comprises the second damper 770. However, the present invention is not limited thereto. Specifically, the piezoelectric speaker 100 may comprise no second damper 770.

Hereinafter, description will be made about movements of components of the piezoelectric speaker 100 when voltage is applied to the piezoelectric element 300.

Referring to FIG. 2, when voltage is applied to the piezoelectric element 300, the piezoelectric element 300 vibrates in flexural mode in a first vibration mode so that only a center part of the piezoelectric element 300 in the perpendicular direction is moved in the up-down direction. In other words, when voltage is applied to the piezoelectric element 300, the piezoelectric element 300 vibrates in flexural mode so that the center part of the piezoelectric element 300 in the perpendicular direction is an antinode while opposite ends of the piezoelectric element 300 in the perpendicular direction is a node. Thus, each of the first damper 756, the spacer 700 and the first damper 754 vibrates in the up-down direction so that the diaphragm 400 vibrates in the up-down direction.

As described above, the edge 500 of the present embodiment is fixed to the upper surface 210 of the frame 200 and supports the outer peripheral end 402 of the diaphragm 400 so that the outer peripheral end 402 of the diaphragm 400 is freely vibratable. Thus, there is no possibility that the vibration of the diaphragm 400 in the up-down direction is avoided by the edge 500, and thereby the vibration force vector transferred from the piezoelectric element 300 to the diaphragm 400 is maintained in the up-down direction at all times while swaying movement of the diaphragm 400 in the perpendicular direction is prevented.

### Second Embodiment

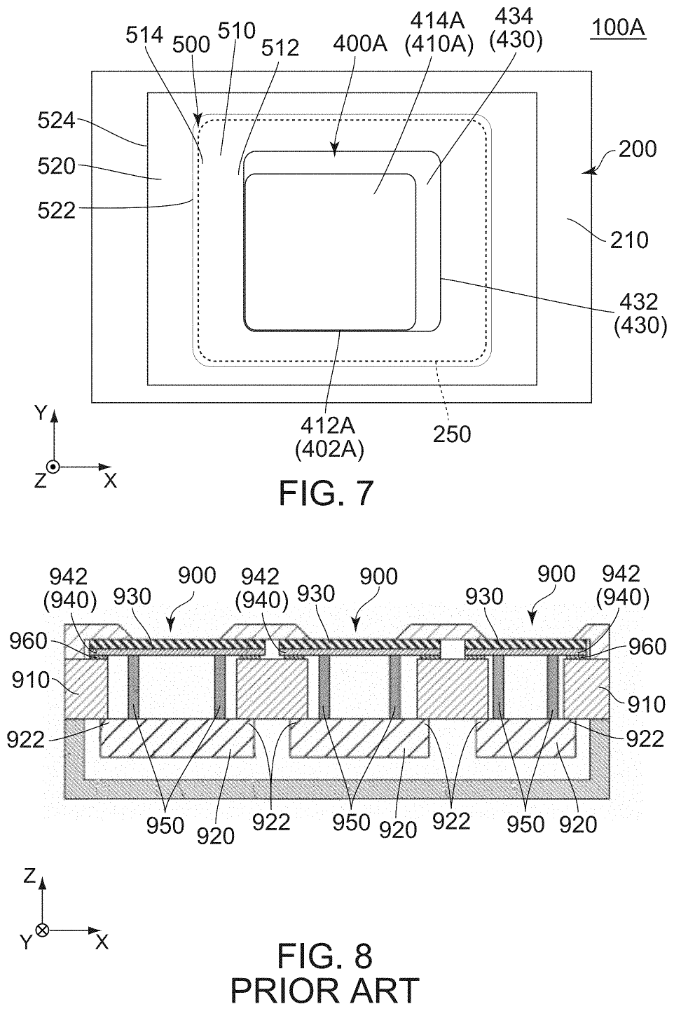

Referring to FIGS. 6 and 7, a piezoelectric speaker 100A according to a second embodiment of the present invention has a structure similar to that of the piezoelectric speaker 100 according to the aforementioned first embodiment as shown in FIG. 1. Components of the piezoelectric speaker 100A shown in FIGS. 6 and 7 which are same as those of the piezoelectric speaker 100 of the first embodiment are referred by using reference signs same as those of the piezoelectric speaker 100 of the first embodiment. As for directions and orientations in the present embodiment, expressions same as those of the first embodiment will be used hereinbelow.

Referring to FIG. 6, the piezoelectric speaker 100A of the present invention comprises a frame 200, a piezoelectric element 300, a diaphragm 400A, an edge 500, an adhesive layer 600, a spacer 700, a cover (not shown) and a supporting portion (not shown). The piezoelectric speaker 100A of the present embodiment has a predetermined region 250 therein. The components of the piezoelectric speaker 100A of the present embodiment other than the diaphragm 400A have structure same as those of the piezoelectric speaker 100 of the aforementioned first embodiment. Accordingly, detailed explanation thereabout is omitted.

Referring to FIG. 6, the diaphragm 400A of the present embodiment is made of resin. More specifically, the diaphragm 400A is made of polyethylene terephthalate (PET). The diaphragm 400 has a flat-plate shape perpendicular to the up-down direction. As shown in FIG. 7, the diaphragm 400A has an outer peripheral end 402A in a perpendicular direction perpendicular to the up-down direction. The outer peripheral end 402A of the diaphragm 400A has a substantially rectangular shape. The substantially rectangular shape of the outer peripheral end 402A has two sides, each of which is parallel to the first horizontal direction perpendicular to the up-down direction, and two sides each parallel to the second horizontal direction perpendicular to both the up-down direction and the first horizontal direction.

As shown in FIG. 6, the diaphragm 400A of the present embodiment has an upper surface 414A and a lower surface 436 in the up-down direction. The diaphragm 400A is positioned above the predetermined region 250 in the up-down direction. Specifically, the lower surface 436 of the diaphragm 400A is positioned above the predetermined region 250 in the up-down direction. As shown in FIG. 7, the outer peripheral end 402A of the diaphragm 400A is positioned inside the predetermined region 250 in a horizontal plane perpendicular to the up-down direction. Specifically, the outer peripheral end 402 of the diaphragm 400 is positioned inward of the predetermined region 250 in the perpendicular direction perpendicular to the up-down direction.

The diaphragm 400A meets an inequality of 100 MPa≤G1≤4 MPa, where G1 is a Young's modulus of the diaphragm 400A. When the diaphragm 400A having a Young's modulus G1 of less than 100 MPa is pushed by the piezoelectric element 300 via the spacer 700, the diaphragm 400A is not moved uniformly and only a part of the diaphragm 400A, which is directly pushed by the spacer 700, is moved. Accordingly, the diaphragm 400A having a Young's modulus G1 of less than 100 MPa cannot produce a high sound pressure level. Thus, it is unfavorable for the diaphragm 400A to have a Young's modulus G1 of less than 100 MPa. Specifically, when the diaphragm 400A having a Young's modulus G1 of less than 100 MPa is pushed by the piezoelectric element 300 via the spacer 700, the part of the diaphragm 400A, which is directly pushed by the spacer 700, is synchronously moved with the spacer 700 while a remaining part of the diaphragm 400A, which is not directly pushed by the spacer 700, is not synchronously moved with the spacer 700. Accordingly, the diaphragm 400A having a Young's modulus G1 of less than 100 MPa cannot produce a high sound pressure level. Thus, it is unfavorable for the diaphragm 400 to have a Young's modulus G1 of less than 100 MPa. If the diaphragm 400A has a Young's modulus G1 of more than 4 MPa, the diaphragm 400A, which is pushed by the piezoelectric element 300, is mainly moved to be bent. Thus, it is unfavorable for the diaphragm 400A to have a Young's modulus G1 of more than 4 GPa.

The diaphragm 400A meets an inequality of 0.04 g≤W≤0.1 g, where W is a weight of the diaphragm 400A. If W is more than 0.1 g, the piezoelectric element 300, which is required for driving the diaphragm 400A, must have an increased size and an increased number of the stacked piezoelectric layers so that the piezoelectric element 300 has an increased cost. Thus, it is unfavorable for the diaphragm 400A to have a weight W of more than 0.1 g.

As shown in FIG. 6, the diaphragm 400A of the present embodiment comprises a main vibration portion 410A and a supporting body 430. The supporting body 430 of the present embodiment has a structure same as that of the supporting body 430 of the aforementioned first embodiment. Accordingly, detailed explanation thereabout is omitted.

As shown in FIG. 6, the main vibration portion 410A has a flat-plate shape perpendicular to the up-down direction. A center CA of the main vibration portion 410A in a plane perpendicular to the up-down direction is offset from a center line L which passes through a center C of the supporting body 430 in the plan perpendicular to the up-down direction and which is parallel to the up-down direction. In other words, the center CA of the main vibration portion 410A is not positioned on the center line L of the supporting body 430. The main vibration portion 410A has an outer peripheral end 412A in the perpendicular direction. The outer peripheral end 412A is exposed to the outside of the diaphragm 400A in the perpendicular direction. The main vibration portion 410A has an upper surface 414A and a lower surface 416A in the up-down direction. The upper surface 414A is exposed to the outside of the diaphragm 400A.

As shown in FIG. 6, the piezoelectric speaker 100A of the present embodiment further comprises a second damper 770A. The second damper 770A is made of resin. More specifically, the second damper 770A is a double-sided tape which is formed from a base member made of polyethylene terephthalate (PET) whose upper and lower sides are coated with acrylic adhesive.

As shown in FIG. 6, the second damper 770A is arranged between the main vibration portion 410A and the supporting body 430 in the up-down direction. The second damper 770A has an outer peripheral end 772A in the perpendicular direction. Specifically, the outer peripheral end 402A of the diaphragm 400A consists of the outer peripheral end 412A of the main vibration portion 410A, the outer peripheral end 772A of the second damper 770A and the outer peripheral end 432 of the supporting body 430. The second damper 770A has an upper surface 774A and a lower surface 776A in the up-down direction.

As shown in FIG. 6, the second damper 770A of the present embodiment is attached on the main vibration portion 410A in the up-down direction. More specifically, the upper surface 774A of the second damper 770A is attached on the lower surface 416A of the main vibration portion 410A in the up-down direction. The center CA of the main vibration portion 410A and a center CB of the second damper 770A in the plane perpendicular to the up-down direction are positioned on a common axis parallel to the up-down direction

As shown in FIG. 6, the second damper 770A of the present embodiment is attached on the supporting body 430 in the up-down direction. More specifically, the lower surface 776A of the second damper 770A is attached on the upper surface 434 of the supporting body 430 in the up-down direction. The center CB of the second damper 770A is offset from the center line L of the supporting body 430. In other words, the center CB of the second damper 770A is not positioned on the center line L of the supporting body 430.

As shown in FIG. 6, the diaphragm 400A of the present embodiment consists of the main vibration portion 410A, the second damper 770A and the supporting body 430. More specifically, the diaphragm 400A of the present embodiment is formed by stacking the main vibration portion 410A, the second damper 770A and the supporting body 430 in that order from the top of the diaphragm 400A in the up-down direction.

Since the piezoelectric speaker 100A of the present embodiment further comprises the second damper 770A, the piezoelectric speaker 100A has a further increased loss around its resonant frequency while having a further reduced loss at a non-resonant frequency so that the piezoelectric speaker 100A can produce a further increased sound pressure level at the non-resonant frequency. In other words, the piezoelectric speaker 100A of the present embodiment can provide a more flatter frequency response in sound pressure level since the piezoelectric speaker 100A further comprises the second damper 770A. However, the present invention is not limited thereto. Specifically, the piezoelectric speaker 100A may comprise no second damper 770A.

As described above, the piezoelectric speaker 100A of the present embodiment is configured so that each of the center CA of the main vibration portion 410A and the center CB of the second damper 770A is offset from the center line L of the supporting body 430. Accordingly, the piezoelectric speaker 100A of the present embodiment can provide a more further flatter frequency response in sound pressure level as compared with a piezoelectric speaker in which each of the center CA of the main vibration portion 410A and the center CB of the second damper 770A is positioned on the center line L of the supporting body 430.

Hereinafter, the embodiment of the invention will be explained in more detail with reference to an example of the embodiment.

### EXAMPLE 1

Referring to FIG. 1, the piezoelectric speaker 100 of Example 1 comprises the frame 200, the piezoelectric element 300, the diaphragm 400, the edge 500, the spacer 700, the first dampers 752, 754 and 756, the second dampers 770, the cover 800 and the supporting portion 850. The frame 200 is made of stainless steel. The frame 200 has a longitudinal size of 13.8 mm, a lateral size of 16.6 mm and a thickness of 0.3 mm. The piezoelectric element 300 is a multilayer piezoelectric element which is formed by stacking twenty eight of piezoelectric layers each having a thickness of 25 μm. The piezoelectric element 300 has a longitudinal size of 4.0 mm, a lateral size of 16.0 mm and a thickness of 0.7 mm. The diaphragm 400 is made of polyethylene terephthalate (PET). The diaphragm 400 has a Young's modulus G1 of 4 GPa and a specific gravity of 0.7 g/cm³. The diaphragm 400 has a longitudinal size of 10 mm, a lateral size of 13 mm and a thickness of 0.5 mm. The edge 500 is made of polyethylene naphthalate. The edge 500 has a Young's modulus G2 of 1 GPa and a specific gravity of 1.1 g/cm³. The edge 500 has a thickness of 38 μm and a radius of curvature R of 0.5 mm. The spacer 700 is made of polycarbonate. The spacer 700 has a longitudinal size of 2 mm, a lateral size of 2 mm and a thickness of 0.2 mm. Each of the first dampers 752, 754 and 756 and the second damper 770 is a double-sided tape which is formed from a base member made of polyethylene terephthalate (PET) whose upper and lower sides are coated with acrylic adhesive. Each of the first dampers 752, 754 and 756 and the second damper 770 has a thickness of 0.1 mm. The cover 800 is made of stainless steel. The cover 800 has a longitudinal size of 13.8 mm, a lateral size of 16.6 mm and a thickness of 0.3 mm. The supporting portion 850 has the right supporting portion 852, the left supporting portion 854 and the rear supporting portion 858. Each of the right supporting portion 852, the left supporting portion 854 and the rear supporting portion 858 is formed by attaching double-sided tapes to a base member made of polycarbonate at its upper and lower sides, wherein each of the double-sided tapes is made of the same material as the first dampers 752, 754, and 756 and the second damper 770. Each of the right supporting portion 852 and the left supporting portion 854 has a longitudinal size of 13.8 mm, a lateral size of 0.5 mm and a thickness of 0.7 mm. The rear supporting portion 858 has a longitudinal size of 0.5 mm, a lateral size of 16.6 mm and a thickness of 0.7 mm. In the Example 1, the longitudinal direction is the Y-direction, the lateral direction is the X-direction and the thickness direction is the Z-direction. The longitudinal direction is the second horizontal direction, the lateral direction is the first horizontal direction and the thickness direction is the up-down direction. The longitudinal direction is also referred to as the front-rear direction, while the lateral direction is also referred to as the right-left direction.

Referring to FIG. 2, the diaphragm 400 of the piezoelectric speaker 100 of Example 1 is configured so that the main vibration portion 410 is attached on the second damper 770 while the second damper 770 is attached on the supporting body 430. The piezoelectric speaker 100 of Example 1 is configured as follows: the supporting body 430 is attached on the first damper 754; the first damper 754 is attached on the spacer 700; the spacer 700 is attached on the first damper 756; the first damper 756 is attached on the piezoelectric element 300; the flat-plate portion 520 of the edge 500 is fixed to the upper surface 210 of the frame 200 via the adhesive layer 600; the lower surface 220 of the frame 200 is attached on the first damper 752; and the first damper 752 is attached on a portion of the piezoelectric element 300 which is positioned around its end in the lateral direction.

Measurement of a sound pressure level produced by the piezoelectric speaker 100 of Example 1 shows that the piezoelectric speaker 100 of Example 1 produces the sound pressure level which is 10 dB higher than that of a piezoelectric speaker of Patent Document 1. Additionally, the measurement shows that the piezoelectric speaker 100 of Example 1 can produce the sound pressure level twice as great as a sound pressure level which is produced by an electromagnetic speaker having the same volume as the piezoelectric speaker 100 of Example 1.

The piezoelectric speaker 100 of the present embodiment has the cover 800 and the supporting portion 850. Thus, in the frequency range of 2 kHz to 20 kHz which is included in the audible range, the piezoelectric speaker 100 of the present embodiment does not have a frequency band whose intensity is extremely reduced. In other words, the piezoelectric speaker 100 of the present embodiment can produce a flatter frequency response in sound pressure level across the frequency range of 2 kHz to 20 kHz.

Since the piezoelectric speaker 100 of the present embodiment has the edge 500, the vibration of the diaphragm 400 is substantially uniform in the plane perpendicular to the up-down direction.

### EXAMPLE 2

Referring to FIGS. 6 and 7, the piezoelectric speaker 100A of Example 2 comprises the frame 200, the piezoelectric element 300, the diaphragm 400A, the edge 500, the spacer 700, the first dampers 752, 754 and 756, the second dampers 770A, the cover (not shown) and the supporting portion (not shown). Components of the piezoelectric speaker 100A of Example 2 other than the diaphragm 400A and the second dampers 770A have structures same as those of Example 1. The diaphragm 400A is made of polyethylene terephthalate (PET). The diaphragm 400A has a Young's modulus G1 of 4 GPa and a specific gravity of 0.7 g/cm³. The diaphragm 400 has a longitudinal size of 10 mm, a lateral size of 13 mm and a thickness of 0.5 mm. The diaphragm 400A has comprises the main vibration portion 410A and the supporting body 430. The center CA of the main vibration portion 410A in the plane perpendicular to the up-down direction is offset from the center line L, which passes through the center C of the supporting body 430 in the plane perpendicular to the up-down direction and is parallel to the up-down direction, by about 0.05 to 0.1 mm in the longitudinal direction and by about 0.05 to 0.1 mm in the lateral direction. The second damper 770A is a double-sided tape which is formed from a base member made of polyethylene terephthalate (PET) whose upper and lower sides are coated with acrylic adhesive. The second damper 770A has a thickness of 0.1 mm. The center CB of the second damper 770A in the plane perpendicular to the up-down direction is offset from the center line L of the supporting body 430 by about 0.05 to 0.1 mm in the longitudinal direction and by about 0.05 to 0.1 mm in the lateral direction. The longitudinal direction and the lateral direction are defined similarly to Example 1.

Referring to FIG. 6, the diaphragm 400A of the piezoelectric speaker 100A of Example 2 is configured so that the main vibration portion 410A is attached on the second damper 770A while the second damper 770A is attached on the supporting body 430.

Measurement of a sound pressure level produced by the piezoelectric speaker 100A of Example 2 shows that the piezoelectric speaker 100A of Example 2 produces the sound pressure level which is 10 dB higher than that of the piezoelectric speaker of Patent Document 1. Additionally, the measurement shows that the piezoelectric speaker 100A of Example 2 can produce the sound pressure level twice as great as a sound pressure level which is produced by an electromagnetic speaker having the same volume as the piezoelectric speaker 100A of Example 2.

The piezoelectric speaker 100A of the present embodiment has the cover and the supporting portion. Thus, in the frequency range of 2 kHz to 20 kHz which is included in the audible range, the piezoelectric speaker 100A of the present embodiment does not have a frequency band whose intensity is extremely reduced. In other words, the piezoelectric speaker 100A of the present embodiment can produce a flatter frequency response in sound pressure level across the frequency range of 2 kHz to 20 kHz.

Since the piezoelectric speaker 100A of the present embodiment has the edge 500, the vibration of the diaphragm 400A is substantially uniform in the plane perpendicular to the up-down direction.

The measurement of the sound pressure level produced by the piezoelectric speaker 100A of Example 2 shows that the piezoelectric speaker 100A of Example 2 can produce a more further flatter frequency response in sound pressure level across the frequency range of 2 kHz to 20 kHz. More specifically, in a specific piezoelectric speaker having a configuration so that each of the center CA of the main vibration portion 410A and the center CB of the second damper 770 is positioned on the center line L of the supporting body 430, a sound pressure level in a frequency range of 9 kHz to 10 kHz is definitely lower than a sound pressure level just outside the frequency range of 9 kHz to 10 kHz. On the contrary, in the frequency range of 9 kHz to 10 kHz, a sound pressure level of the piezoelectric speaker 100A of Example 2 is greater than the sound pressure level of the specific piezoelectric speaker by 12 dB.

In other words, the piezoelectric speaker 100A of Example 2 has a difference between the sound pressure level in the frequency range of 9 kHz to 10 kHz and a sound pressure level just outside the frequency range of 9 kHz to 10 kHz, the specific piezoelectric speaker has a difference between the sound pressure level in the frequency range of 9 kHz to 10 kHz and the sound pressure level just outside the frequency range of 9 kHz to 10 kHz, and the difference of the piezoelectric speaker 100A of Example 2 is smaller than the difference of the specific piezoelectric speaker by 12 dB.

As described above, the piezoelectric speaker 100A of Example 2 is configured so that the center CA of the main vibration portion 410A and the center CB of the second damper 770A is offset from the center line L of the supporting body 430 by about 0.05 to 0.1 mm in the longitudinal direction and by about 0.05 to 0.1 mm in the lateral direction. The measurement confirms that the supporting body 430 is strong enough for the offset thereby.

Although the specific explanation about the present invention is made above referring to the embodiments, the present invention is not limited thereto and is susceptible to various modifications and alternative forms.

Although the diaphragm 400 of the piezoelectric speaker 100 of the present embodiment comprises the main vibration portion 410 and the supporting body 430, the present invention is not limited thereto. Specifically, the diaphragm 400 may be modified so that the diaphragm 400 has no supporting body 430 while the outer peripheral end 412 of the main vibration portion 410 is directly supported by the edge 500. In the modification of the diaphragm 400, the main vibration portion 410 and the edge 500 may be formed by two-color molding.

Although the diaphragm 400A of the piezoelectric speaker 100A of the present embodiment comprises the main vibration portion 410A and the supporting body 430, the present invention is not limited thereto. Specifically, the diaphragm 400A may be modified so that the diaphragm 400A has no supporting body 430 while the outer peripheral end 412A of the main vibration portion 410A is directly supported by the edge 500. In the modification of the diaphragm 400A, the main vibration portion 410A and the edge 500 may be formed by two-color molding.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A piezoelectric speaker comprising a frame, a piezoelectric element, a diaphragm, an edge, a spacer, a cover and a supporting portion, wherein:
the frame surrounds a predetermined region;
the frame has an upper surface and a lower surface in an up-down direction;
the piezoelectric element is fixed to the lower surface of the frame;
the piezoelectric element is positioned below the predetermined region in the up-down direction;
the diaphragm is positioned above the predetermined region in the up-down direction;
the diaphragm has an outer peripheral end in a horizontal plane perpendicular to the up-down direction;
the cover has an outer peripheral end in the horizontal plane;
in the horizontal plane, the outer peripheral end of the diaphragm is positioned inside the outer peripheral end of the cover;
the edge is fixed to the upper surface of the frame;
the edge supports the outer peripheral end of the diaphragm so that the outer peripheral end of the diaphragm is freely vibratable;
the spacer is arranged in the predetermined region;
the spacer is fixed to both of the piezoelectric element and the diaphragm in the up-down direction;
the cover is positioned above the diaphragm in the up-down direction; and
the supporting portion is positioned on the frame and supports the cover.

2. The piezoelectric speaker as recited in claim 1, wherein the cover has a flat-plate shape.

3. The piezoelectric speaker as recited in claim 1, wherein the supporting portion is an elastic body.

4. The piezoelectric speaker as recited in claim 1, wherein the supporting portion is, at least in part, opened in the horizontal plane.

5. The piezoelectric speaker as recited in claim 4, wherein, in the horizontal plane, the supporting portion is opened only at its front end in a front-rear direction perpendicular to the up-down direction.

6. The piezoelectric speaker as recited in claim 1, wherein the diaphragm is completely covered with the cover when the piezoelectric speaker is viewed from above in the up-down direction.

7. The piezoelectric speaker as recited in claim 1, wherein:
the diaphragm has a Young's modulus of G1;
the edge has a Young's modulus of G2; and
1.5≤G1/G2≤5.

8. The piezoelectric speaker as recited in claim 1, wherein the outer peripheral end of the diaphragm is positioned inside the predetermined region in the horizontal plane.

9. The piezoelectric speaker as recited in claim 1, wherein:
the diaphragm has a weight of W; and
0.04 g≤W≤0.1 g.

10. The piezoelectric speaker as recited in claim 1, wherein:
the piezoelectric speaker further comprises at least one first damper;
the piezoelectric speaker has a first boundary between the frame and the piezoelectric element;
the piezoelectric speaker has a second boundary between the spacer and the piezoelectric element;
the piezoelectric speaker has a third boundary between the spacer and the diaphragm; and
the at least one first damper is arranged at at least one of the first boundary, the second boundary and the third boundary.

11. The piezoelectric speaker as recited in claim 1, wherein:
the piezoelectric speaker further comprises a second damper;
the diaphragm comprises a main vibration portion and a supporting body;
the supporting body is formed integrally with the edge; and
the second damper is arranged between the supporting body and the main vibration portion in the up-down direction.

12. The piezoelectric speaker as recited in claim 11, wherein:
the main vibration portion has a center in a plane perpendicular to the up-down direction;
the supporting body has a center in the plane perpendicular to the up-down direction;
the center of the main vibration portion is offset from a center line which passes through the center of the supporting body and which is parallel to the up-down direction;
the second damper has a center in the plane perpendicular to the up-down direction;
the center of the second damper is offset from the center line of the supporting body.

13. The piezoelectric speaker as recited in claim 1, wherein the edge has an arc-like cross-section.
